(19) United States
(12) Patent Application Publication
(10) Pub. No.: US 2025/0122978 A1
(43) Pub. Date: Apr. 17, 2025

(54) SUPPORT SYSTEM FOR DOUBLE-WALL LIQUID HYDROGEN STORAGE VESSEL

(71) Applicant: CB&I STS Delaware LLC, The Woodlands, TX (US)

(72) Inventors: David CREECH, Glen Ellyn, IL (US); Steven Matthew CIHLAR, St. Charles, IL (US); Randy Lee EBERLY, Plainfield, IL (US)

(21) Appl. No.: 18/912,126

(22) Filed: Oct. 10, 2024

Related U.S. Application Data
(60) Provisional application No. 63/590,096, filed on Oct. 13, 2023.

(51) Int. Cl. F17C 3/08

(52) U.S. Cl. CPC F17C 3/08; F17C 2201/0104; F17C 2201/035; F17C 2203/015; F17C 2203/0391; F17C 2203/0629; F17C 2203/0643; F17C 2203/0646; F17C 2221/012; F17C 2223/0161

(57) ABSTRACT

A method and apparatus for storing a cryogenic material, such as liquid hydrogen is described. The apparatus includes a liquid hydrogen storage container with a structural support system that enables frequent loading and unloading of the structural support system. The structural support system enables loading and unloading without permanent deformation or fatigue of the structural support system. The structural support system includes a plurality of support members which are oriented at an angle tangent to a portion of an inner shell, which forms a cavity holding the cryogenic material. The portion of the inner shell which the support member is tangent to is the portion of the inner shell closest to an end of the support member.

### CROSS-REFERENCE TO RELATED APPLICATIONS

This application claims the benefit of U.S. Provisional Application 63/590,096 filed on Oct. 13, 2023, which are herein incorporated by reference in their entirety.

### BACKGROUND

### Field

Embodiments of the present disclosure generally relate to a structural support system within a liquid gas storage container, such as a liquid hydrogen storage container, which enables cyclic heating and cooling of the storage container for maintenance, inspection, and evacuation purposes.

### Description of the Related Art

Hydrogen is an energy source that is an alternative to conventional fossil fuels. For example, some modes of transportation, such as cars, are powered by hydrogen fuel cells. Hydrogen also has applications in other industrial applications, such as the Haber-Bosh process to produce fertilizer. As demand for hydrogen increases, due in part to the development of more efficient hydrogen powered vehicles and machines and consumer adoption thereof, there is a need to store and transport hydrogen in industrial quantities.

Hydrogen gas has a low density. To efficiently store industrial quantities of hydrogen gas, the hydrogen gas is liquefied. However, the temperature of liquefied hydrogen gas may place stress on its container. For example, the boiling point of liquefied hydrogen gas at one atmosphere of pressure is about −252.8° C. Most metals, including those that are compatible with hydrogen exposure, contract when exposed to temperatures lower than ambient temperature.

Conventional liquid hydrogen storage vessels are formed from a double steel walled vessel with a vacuum insulation. The storage vessels may be used on land or ships. The inner steel vessel wall storing the liquid hydrogen is suspended from the outer steel vessel wall. A system of structural supports extend from the inner vessel to the outer vessel. The structural supports pass through an annular insulation space and provide a path for heat to conduct from the outer sphere to the inner sphere. Typically, these structural supports are designed to be long and have a small cross-sections to limit heat ingress and unwanted boil off. Structural supports loaded in tension may be designed with a smaller cross sectional area than supports loaded in compression. The structural supports are configured to be strong enough to withstand both the weight of the product and the inner vessel itself as well as inertial forces that may be generated from external loads such as seismic events or wave loading.

The structural supports may shrink (e.g., contract) during cooling of the support due to thermal strain. Additionally, the distance between the inner vessel and the outer vessel increases due to the shrinking of the inner vessel while the outer vessel stays at about the same size. The mechanical tensile strain within the structural supports, caused by the loading of the support members and changes in dimension, can be higher than the yield strain of the material. Therefore, structural supports that are initially loaded in warm conditions will be permanently deformed.

Most current land-based large-scale hydrogen storage vessels experience very few full cooling and heating cycles. For example, many storage vessels supply liquid hydrogen fuel for spacecraft. The vessels are operated such that full warm-up and cool-down cycles are intentionally limited. The vessels, once cooled down, are maintained at a cryogenic temperature continuously. Additionally, there are few significant lateral loading cycles because seismic events are relatively rare in most regions. Therefore, any plastic deformation of the structural supports, which occurred during a first cool-down cycle, or accommodation to avoid plastic deformation such as allowing for slack in the supports in the warm conditions, have reduced adverse effects on the long-term operation of the vessel.

New applications for liquid hydrogen storage are more likely to experience frequent loading and unloading of the structural supports. In energy export and import applications, onshore storage vessels may be substantially emptied every one to four weeks, causing frequent cyclic thermal strains under normal operating conditions. Storage vessels on ships would additionally be exposed to inertial forces due to waves and will be taken out of service at least every five years for inspection and maintenance. Theses thermal and inertial forces can cause significant cyclic loading of the supports. Plastic deformation of the supports or accommodations for thermal shrinkage during cold cool-down will normally slacken the supports when warmed in conventional configurations and can significantly reduce the life of the supports.

Therefore, there is a need in the art for new structural support systems between the inner vessel and the outer vessel of liquid hydrogen storage containers.

### SUMMARY

The present disclosure generally relates to a cryogenic vessel for storing a cryogenic material.

In one embodiment, a liquid gas storage container is disclosed. The liquid gas storage container includes an inner shell, an outer shell disposed around the inner shell, and a plurality of support members disposed between the inner shell and the outer shell. The inner shell includes an inner surface forming a cavity, and an outer surface. Each of the plurality of supports includes a first end coupled to the inner shell at an angle about tangent to the outer surface of the inner shell at a point where the first end is closest to the outer surface, and a second end coupled to the outer shell.

In another embodiment, a liquid gas storage container is disclosed. The liquid gas storage container includes an inner shell, an outer shell disposed around the inner shell, and a plurality of support members disposed between the inner shell and the outer shell. The inner shell includes an inner surface forming a cavity and an outer surface. Each of the plurality of supports includes a first end coupled to the inner shell at an angle about tangent to the outer surface of the inner shell at a point where the first end is closest to the outer surface, a second end coupled to the outer shell, and a bracket offsetting the first end from the outer surface of the inner shell.

In another embodiment, a liquid gas storage container is disclosed. The liquid gas storage container includes an inner shell, an outer shell disposed around the inner shell, and a support structure disposed between the first outer surface and the second inner surface. The inner shell includes a first inner surface forming a cavity and a first outer surface. The outer shell comprises a second inner surface. The support structure includes a first support ring contacting the first outer surface, a second support ring contacting the second inner surface, and a plurality of support members disposed between the inner shell and the outer shell. Each of the plurality of supports includes a first end coupled to a first bracket within the first support ring and a second end coupled to a second bracket within the second support ring. The first end is disposed at an angle about tangent to the outer surface of the inner shell at a point where the first end is closest to the outer surface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1A is a schematic cross-sectional side view of a liquid gas container, according to one embodiment described herein.

FIG. 1B is a schematic cross-sectional side view of a spherical liquid gas container, according to one embodiment described herein.

FIG. 2 is a schematic cross-sectional plan view of a liquid gas container, according to one embodiment described herein.

FIG. 3A is a schematic cross-sectional plan view of a portion of a liquid gas container and a support member, according to a first embodiment described herein.

FIG. 3B is a schematic cross-sectional plan view of a portion of a liquid gas container and a support member, according to a second embodiment described herein.

FIG. 4 is a schematic cross-sectional plan view of a structural support system, according to one embodiment described herein.

FIG. 5A is a schematic top view of a bracket, according to one embodiment described herein.

FIG. 5B is a schematic side view of the bracket, according to one embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to a cryogenic storage container for storing a cryogenic material. More specifically, the present disclosure relates to a liquid hydrogen storage container and a structural support system, which enables reduction of cyclic load without slack in the supports for the full range of cryogenically cooled and warmed ambient states. The structural support system is configured such that each individual support member that extends between an inner shell and an outer shell does not require the supports to be released from the load in the warm condition and is not plastically strained under cryogenically cooled and/or cyclical loading conditions.

Conventional support members utilized in liquid hydrogen storage containers can be divided into two types. There are substantially vertical support members and substantially horizontal support members. The vertically oriented support members support the weight of the product, the vessel, and vertical accelerations. The horizontally oriented support members support horizontal accelerations (e.g., lateral force resisting system). Both types of support members may be used together in one storage container.

One factor in the design of the support members is the change in dimensions of the inner and outer shells due to thermal contraction. The diameter of the outer shell will reduce by a small amount when air in the insulation space is evacuated. However, the diameter of the inner shell is reduced by a more significant amount when the inner shell is cooled down by liquid hydrogen. The diameter of a stainless steel inner shell may reduce by approximately 0.3% when brought from an ambient temperature to a temperature for storing liquid hydrogen (such as at or below 20 degrees Kelvin).

Although this is a small percentage of the inner sphere diameter, a 0.3% contraction is large compared to the radial dimension of the annular space between the inner shell and the outer shell and the support members spanning the annular space between the inner shell and the outer shell. The structural members, disclosed herein, accommodate a large relative displacement between the inner and outer shells caused by the inner shell moving radially inward, away from the outer shell, during cool-down.

The support members themselves also cool down with the inner vessel. The average temperature of each support member is approximately the average of a temperature of the inner shell and a temperature of the outer shell. This causes thermal contraction of the member at the same time that a gap D between the inner shell and the outer shell is expanding.

To reduce the strain on the support members, the support members are oriented such that they are tangent to a surface of the inner shell closest to the end of the support member connected to the inner shell. Therefore, as the distance between the inner shell and the outer shell changes, the support member changes orientation relative to one or both of the inner shell and the outer shell. The change in orientation reduces the strain in the support member, thus preventing fatigue. The change in orientation may be enabled at least in part by one or more brackets with one or more pins disposed therein, such that each support member is coupled to a first bracket. The first bracket is coupled to the outside surface of the inner shell and a second bracket is coupled to the inside surface of the outer shell. Each bracket includes a pin. An end of each support member is coupled to each pin, such that the support member rotates around the pin, or around a central axis of the pin, to change orientation.

Although the embodiments described herein are directed towards commercial storage containers for liquid hydrogen or other liquid gases, such as liquid helium, liquid nitrogen, liquid oxygen, or other liquefied gases, it is contemplated that the embodiments described herein could also be utilized to support one or more pipelines. The liquid hydrogen containers described herein could be on the ground or could be on a ship or other offshore platform.

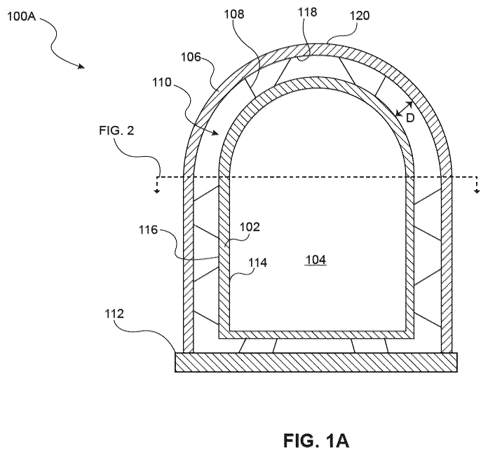

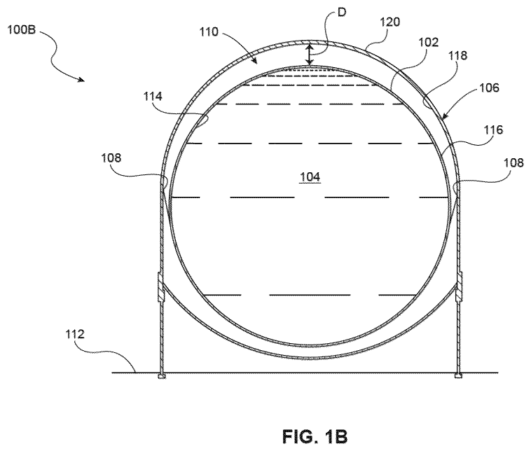

FIG. 1A is a schematic cross-sectional side view of a liquid gas container 100A. FIG. 1B is a schematic cross-sectional side view of a spherical liquid gas container 100B. The liquid gas container 100A includes an inner shell 102, an outer shell 106, and a plurality of support members 108 disposed between the inner shell 102 and the outer shell 106. An inner surface 114 of the inner shell 102 forms a cavity 104.

The cavity 104 is configured to contain a liquid gas at a low temperature, such as liquid hydrogen at a temperature of at or below 20 degrees Kelvin. The cavity 104 is large enough to be used for liquid hydrogen storage on a commercial scale. In some examples, the cavity 104 has a volume of up to about 1,000 m³. In other examples, the cavity 104 has a volume greater than about 1,000 m³ such as greater than about 1,300 m³, such as greater than about 3,000 m³, such as greater than about 5,000 m³, such as up to about 100,000 m³. It is noted that other sizes are also contemplated.

The inner shell 102 has the inner surface 114 and an outer surface 116. The inner shell 102 is a cryogenic material, such as a cryogenic metal, a cryogenic metal alloy, fiberglass laminates (e.g., G-10), or other cryogenic materials. The thickness of the inner shell 102 is configured to support the weight of the liquid stored within the cavity 104 and may also be configured to enable the cavity 104 to be pressurized.

The outer shell 106 includes an inner surface 118 and an outer surface 120. The outer surface 120 is exposed to ambient air. An insulation cavity 110 is formed between the inner surface 118 of the outer shell 106 and the outer surface 116 of the inner shell 102. The outer shell 106 may be formed of a similar or same material as the inner shell 102 or may be formed of a different material. The outer shell 106 is configured to contain the inner shell 102 and provide structural support to the outer shell 106 and insulation disposed within the insulation cavity 110. The insulation cavity 110 may be a vacuum cavity and/or may have one or more layers of insulation disposed therein. The insulation cavity 110 is configured to insulate the inner shell 102 and the cavity 104 to reduce the amount of boil-off of hydrogen within the cavity 104.

The plurality of support members 108 are disposed between the inner surface 118 of the outer shell 106 and the outer surface 116 of the inner shell 102. The plurality of support members 108 are configured to protect and support the inner shell 102 against loads applied to the inner shell 102. Each of the support members 108 may be formed of a material with sufficient structural integrity to withstand the weight of both the inner shell 102, the liquid within the cavity 104, and any acceleration loads. Acceleration loads include those that occur during seismic events or jostling from waves and currents offshore. The outer shell 106 and the inner shell 102 are disposed on a platform 112, in some embodiments. The platform 112 may be a support slab, such as a concrete slab.

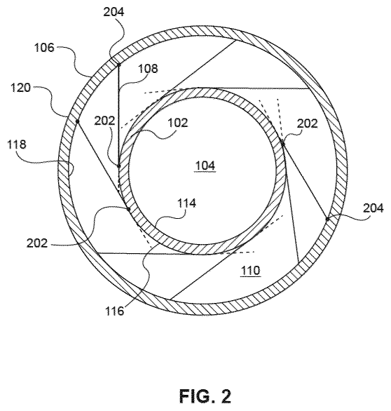

FIG. 2 is a schematic, cross-sectional plan view of the liquid gas container 100A of FIG. 1A. Each of the support members 108 are coupled to the inner shell 102 at an angle which is about tangent to the outer surface 116 of the inner shell 102 at a first connection point 202. The first connection point 202 is the location on the outer surface 116 of the inner shell 102 where the support member 108 is closest to the outer surface 116 of the inner shell 102. The angle being about tangent to the outer surface of the inner shell means that the angle of the length of the support member 108 relative to the outer surface 116 is about zero degrees plus or minus about 5 degrees, such as about zero degrees plus or minus about 3 degrees, such as about zero degrees plus or minus about 1.5 degrees, such as about zero degrees plus or minus about 1 degree. A second end 312 of each support member 108 is connected to the outer shell 106 at a second connection point 204. Both of the first connection point 202 and the second connection point 204 may be flexible connections, such that the support member 108 has some form of limited movement.

As shown in FIG. 2, the cross-section of the liquid gas container 100A is a circle. However, other cross-sectional shapes may also be utilized. When the liquid hydrogen product must be stored at a pressure significantly above ambient pressure the most-straightforward geometry of the inner shell 102 is a sphere, but non-spherical pressure vessel shapes (with generally rounded geometry) are possible. When the liquid hydrogen product can be stored at or near ambient pressure, vessels of other shapes, such as a cylinder, may be used.

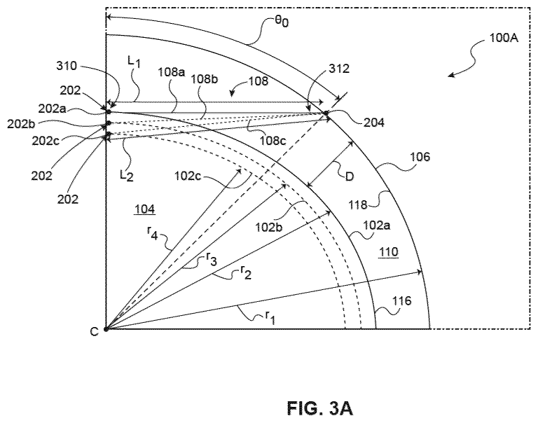

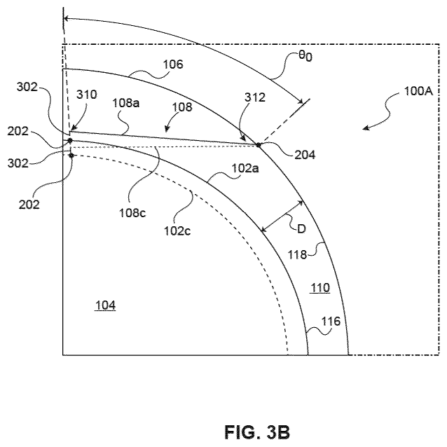

FIG. 3A is a schematic, cross-sectional view of a portion of the liquid gas container 100A and support member 108. The support member 108 is shown in a first support member position 108a at a first temperature, a second support member position 108b at a second temperature, and a third support member position 108c at a third temperature. An inner shell 102 is cooled when a liquid hydrogen is flowed into the cavity 104. Cooling of the inner shell 102 causes the inner shell 102 to shrink from a first shell position 102a (e.g., a warm shell position) to a second shell position 102b (e.g., an average shell position) to a third shell position 102c (e.g., a cold shell position). Since the outer shell 106 is separated from the inner shell 102 by the insulation cavity 110, the outer shell 106 does not generally shrink.

Each support member 108 moves with the inner shell 102 as the inner shell 102 is heated or cooled. Therefore, the support member 108 goes from the first support member position 108a (e.g., a warm support member position) when the inner shell 102 is in the first shell position 102a, to a second support member position 108b (e.g., an average support member position) when the inner shell 102 is in the second shell position 102b, to the third support member position 108c (e.g., a cold support member position) when the inner shell 102 is in a third shell position 102c. In some embodiments, the second support member position 108b may be an average of the first support member position 108a and the third support member position 108c. The second support member position 108b is also the position of the support member 108 when the inner shell 102 is in the second shell position 102b.

A first end 310 of the support member 108 connects to the inner shell 102 at a first connection point 202 and a second end 312 of the support member 108 connects to the outer shell 106 as a second connection point 204. When the inner shell 102 is in a first shell position 102a and first support member position 108a, the first end 310 of the support member 108 connects to a first position first connection point 202a. When the inner shell 102 is in a second shell position 102b and second support member position 108b, the first end 310 of the support member 108 connects to a second position first connection point 202b. When the inner shell 102 is in a third shell position 102c and third support member position 108c, the first end 310 of the support member 108 connects to a third position first connection point 202c.

When the support member 108 is in the first support member position 108a, the support member 108 has a first length L₁. When the support member 108 is in the third support member position 108c, the support member 108 has a second length L₂. There is a difference in angle θₒ between a first connection point 202 and a second connection point 204. The difference in angle θₒ is measured from a central point C, or a central axis, within the inner shell 102. The first connection point 202 is taken as a position while the inner shell 102 is at the second shell position 102b. The difference in angle θₒ is chosen such that as the support members 108 move from the first support member position 108a to the third support member position 108c, the mechanical strain in the support members 108 is reduced or eliminated.

The radius of the inner surface 118 of the outer shell 106 from the central point C is a first radius r₁. The radius of the inner surface 114 of the inner shell 102 while in a first shell position 102a is a second radius r₂. The radius of the inner surface 114 of the inner shell 102 while in a third shell position 102c is a fourth radius r₄. The radius of the inner surface of the inner shell 102 while in the second shell position 102b is a third radius r₃. In some embodiments, the third radius r₃ is an average of the second radius r₂ and the fourth radius r₄, such that the third radius r₃ is (r₂+r₄)/2. A difference in radius Δr is the difference between the second radius r₂ when the inner shell 102 is in a first shell position 102a and the fourth radius r₄ when the inner shell 102 is in a third shell position 102c. Therefore, the difference in radius Δr is (r₂-r₄)

If the support members 108 are made of a material which expands or contracts when heated or cooled, respectively, such that the support members 108 have a thermal expansion coefficient of greater than about 2×10⁻⁶, then the thermal expansion of the support members 108 is taken into consideration when determining the difference in angle θₒ between the first connection point 202 and the second connection point 204 for reducing or eliminating mechanical strain in the support members 108. An average thermal strain eth for each support member 108 is considered. The average thermal strain eth is the amount of strain introduced into each support member 108 on average by the change in temperature from the warm temperature (T₁) to the cold temperature (T₂). The average strain eth for a support member 108 with a non-constant temperature is calculated by integrating the thermal expansion coefficient (as a function of temperature of the support member 108 at a point) multiplied by the temperature difference (the ambient temperature minus the current temperature at a point) along the length of the support member 108. The warm temperature is the temperature of ambient air around the outer shell 106 or room temperature. The cold temperature is the temperature at which liquid hydrogen, or any other product within the cavity 104, is stored. Therefore, the difference in angle θₒ is found using equation 1 as shown below:

$$θ o = ArcCos [ \frac{2 {r}_{2} ( Δ r ) + {( Δ r )}^{2} - {( Δ r )}^{2} ϵ th ( 2 + ϵ th ) - {{r}_{1}}^{2} ϵ th ( 2 + ϵ th )}{2 {r}_{1} ( ( Δ r ) - {r}_{2} ϵ th ( 2 + ϵ th ) )} ] ∓ {5}^{∘} \qquad ( 1 )$$

When the thermal expansion coefficient in the support member 108 is close to zero, such as less than about 2×10⁻⁶, the thermal strain within the support member 108 may be assumed to be zero and equation 1 simplifies to equation 2. Therefore, the difference in angle θₒ is found using equation 2 as shown below:

$$θ o = ArcCos [ - \frac{- 8 {r}_{2} - 4 Δ {r}_{2}}{8 {r}_{1}} ] \qquad ( 2 )$$

In embodiments wherein the support member 108 has a thermal strain caused by heating and cooling of the support member 108, the first length L₁ and the second length L₂ will be different, such that the first length L₁ is longer than the second length L₂. The location of the second connection point 204 relative to the first connection point 202 is determined using equation 1 when the support member 108 undergoes thermal strain. The location of the second connection point 204 relative to the first connection point 202 enables the mechanical strain within the support member 108, caused by the reduction in size of the support member 108 and the inner shell 102 as the temperature of the inner shell 102 and the outer shell 106 decreases, to be reduced or eliminated. The location of the second connection point 204 relative to the first connection point 202 is determined using equation 2 when the support member 108 undergoes very little or no thermal strain.

FIG. 3B is a schematic cross-sectional plan view of a portion of a liquid gas container 100A and a support member 108 which is offset from touching the outer surface 116 of the inner shell 102 by a bracket 302. The amount of support member shrinkage that can be accommodated by geometry of the liquid gas container 100A is limited. Therefore, when the thermal strain of the support member 108 is greater than zero, the support member 108 may need to be connected to the outer surface 116 of the inner shell 102 at a point that is past the portion of the outer surface 116 that is tangent to the support member 108. This is because, for large strains, the angle θ0 may become too large to prevent interference between the support member 108 and the inner shell 102. When the thermal strains become too large, the outer surface 116 would intersect the support member 108 before the first connection point 202 while the support member 108 was in the first support member position 108a and the inner shell 102 was in a first shell position 102a. However, a bracket or a separator, such as the bracket 302, can be utilized to space the first end 310 of the support member 108 from the outer surface 116 of the inner shell 102 such that the support member 108 does not intersect the inner shell 102 at any point between the first support member position 108a and the third support member position 108c.

To reduce or eliminate the need for spacing from one or more brackets 302, the thermal strain in the support member 108 may be reduced. The thermal strain within the support members 108 may be reduced by utilizing support member materials which have low coefficients of thermal expansion. Certain alloys such as iron nickel alloys (e.g., Invar 36) have very low coefficients of thermal contraction at cryogenic temperatures. Other materials which may be utilized include materials with a low thermal expansion coefficient and high ductility at cryogenic temperatures. By designing the support member 108 with a low coefficient of thermal contraction material and selecting the geometry by the equations above, the mechanical strains in the support member 108 during vessel cool-down can be reduced or eliminated. Reducing the mechanical strains in the support members 108 provides greater capacity for mechanical loads (such as lateral accelerations) without fatigue damage of the support members.

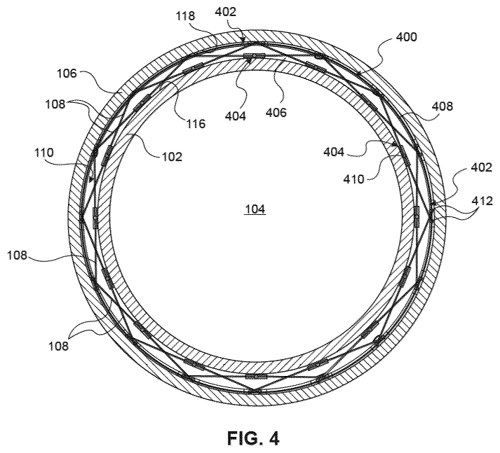

FIG. 4 is a schematic cross-sectional plan view of a structural support system 400 that is configured to be placed between the inner surface 118 of the outer shell 106 and the outer surface 116 of the inner shell 102. The structural support system 400 is placed within the insulation cavity 110 and includes a plurality of support members 108. The structural support system 400 further includes an inner ring 406 and an outer ring 408 in which the plurality of support members 108 are disposed.

The inner ring 406 is coupled to the outer surface 116 of the inner shell 102 and includes a plurality of brackets 404 disposed therein. The plurality of brackets 404 are configured to receive a first end, such as the first end 310, of each support member 108. The brackets 404 space the support members 108 from the outer surface 116 of the inner shell 102 in order to reduce the amount of thermal contraction by the support member 108, and allow some limited freedom of motion to each of the support members 108 to account for a change in position of the inner shell 102 as the temperature of the inner shell 102 changes. Each of the brackets 404 has one or more pins 410 disposed therein. The one or more pins 410 allow the support members 108 to move as the support members 108 may rotate around the pins 410 or the pins 410 may rotate with the support members 108 about a central axis of each pin 410. To facilitate rotation, bushings, bearings, lubricants, surface preparations or surface coatings may optionally be employed.

The outer ring 408 is coupled to the inner surface 118 of the outer shell 106 and includes a plurality of brackets 402 disposed therein. The plurality of brackets 402 are configured to receive a second end, such as the second end 312, of each support member 108. The brackets 402 space the support members 108 from the inner surface 118 of the outer shell 106 in order to reduce the amount of thermal contraction by the support member 108, and allow some limited freedom of motion to each of the support members 108 to account for a change in position of the inner shell 102 as the temperature of the inner shell 102 changes. Each of the brackets 402 has one or more pins 412 disposed therein. The one or more pins 412 allow the support members 108 to move as the support members 108 may rotate around the pins 412 or the pins 412 may rotate with the support members 108 about a central axis of each pin 412. To facilitate rotation, bushings, bearings, lubricants, surface preparations or surface coatings may optionally be employed.

There may be two different sets of support members 108 within the structural support system 400. The sets of support members 108 may be positions to overlap or cross, but not contact, one another. By having overlapping or crossing support members 108, the structural support system 400 has greater structural integrity as the forces within one support member 108 may balance the forces within another support member 108 which is oriented in a mirrored direction.

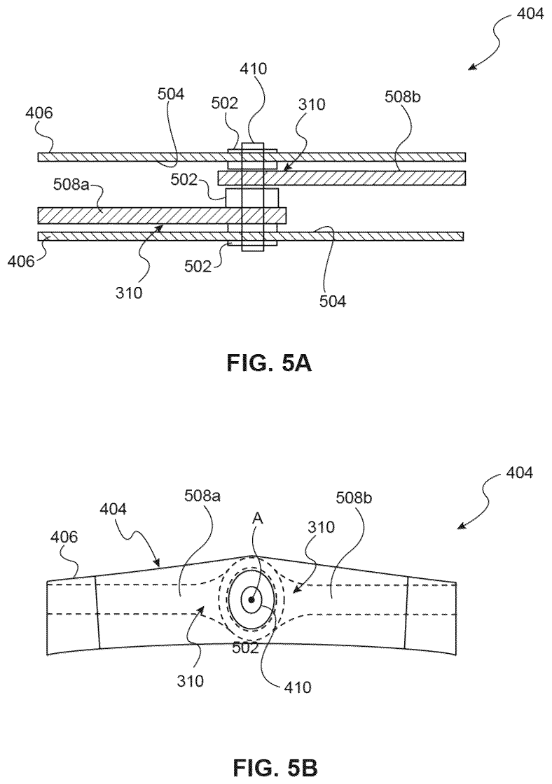

FIG. 5A is a schematic top view of a bracket 404. The bracket 404 includes first ends 310 of both a first support member 508a and a second support member 508b. Each of the first support member 508a and the second support member 508b are disposed around a pin 410. The pin 410 is a cylindrical shaft. Each of the first support member 508a and the second support member 508b actuate around the pin 410 while the pin 410 remains in place. In some embodiments, there are separate pins around which each of the first support member 508a and the second support member 508b are disposed. In these embodiments, the pin 410 may rotate along with each of the first support member 508a or the second support member 508b. One or more separators 502 may be disposed between each of the first support member 508a, the second support member 508b, and the walls 504 of the bracket 404.

FIG. 5B is a schematic side view of the bracket 404. As shown in FIG. 5B, the pin 410 includes an axis A about which both the first support member 508a and the second support member 508b may rotate.

The apparatus described herein can be utilized to enable improved storage of liquid hydrogen or other liquid gases. Embodiments described herein enable the support members to avoid passing the yield strain of the support members during cooling or heating of an inner shell which is configured to hold a liquid gas at low temperatures. Because less strain and stress is placed on each of the support members while in a resting state, such as while in a cooled or a heated state, the support members have greater remaining strain and stress capacity for mechanical loads. Mechanical loads include inertial forces from seismic accelerations or wave action from offshore applications. Fatigue damage to the support members is decreased. The strain on each of the support members is reduced by orienting each support member so that an end of each support member which is connected to the inner shell is tangent to the surface of the inner shell at a location of the surface which is closest to the end of the support member. In some embodiments where the support members themselves have thermal strain, a bracket may be utilized to separate the first end of the support member from the outer surface of the inner shell. This is done to prevent the support member from contacting the outer surface when the inner shell is in a cryogenic condition.

While the foregoing is directed to embodiments of the present disclosure, other and further embodiments of the disclosure may be devised without departing from the basic scope thereof, and the scope thereof is determined by the claims that follow.

What is claimed is:

1. A liquid gas storage container comprising:
an inner shell, comprising:
an inner surface forming a cavity; and
an outer surface;
an outer shell disposed around the inner shell; and
a plurality of support members disposed between the inner shell and the outer shell, each of the plurality of supports comprising;
a first end coupled to the inner shell at an angle about tangent to the outer surface of the inner shell at a point where the first end is closest to the outer surface; and
a second end coupled to the outer shell.

2. The liquid gas storage container of claim 1, wherein the first end is coupled to the inner shell with a bracket.

3. The liquid gas storage container of claim 2, wherein the second end is coupled to the outer shell with a bracket.

4. The liquid gas storage container of claim 1, wherein each of the plurality of support members is a metal or a metal alloy material.

5. The liquid gas storage container of claim 4, wherein the metal or metal alloy material is stainless steel or aluminum.

6. The liquid gas storage container of claim 1, wherein both of the inner shell and the plurality of support members are formed of a cryogenic metal material.

7. The liquid gas storage container of claim 1, wherein each of the plurality of support members have a linear thermal expansion coefficient of less than about 2×10⁻⁶.

8. The liquid gas storage container of claim 7, wherein each of the plurality of support members are a material having a low coefficient of thermal expansion.

9. The liquid gas storage container of claim 6, wherein the cavity has a volume of greater than 1,300 m³.

10. The liquid gas storage container of claim 1, wherein a difference in angle between a first connection point of the first end and a second connection point of the second end of each of the plurality of support members, as measured from a central point within the inner shell, is determined using a formula of
$$θ o = ArcCos [ \text{} \frac{2 {r}_{2} ( {r}_{2} - {r}_{4} ) + {( {r}_{2} - {r}_{4} )}^{2} - {( {r}_{2} - {r}_{4} )}^{2} ϵ th ( 2 + ϵ th ) - {{r}_{1}}^{2} ϵ th ( 2 + ϵ th )}{2 {r}_{1} ( ( {r}_{2} - {r}_{4} ) - {r}_{2} ϵ th ( 2 + ϵ th ) )} ] ∓ {5}^{∘} ,$$
wherein θo is the difference in angle between the first connection point and the second connection point, r₂ is a radius of the inner shell at an ambient temperature, r₄ is a radius of the inner shell at a cryogenic temperature, r₁ is a radius of the outer shell at the ambient temperature, and eth is an average thermal strain of each of the plurality of support members across a length of each of the plurality of support members.

11. The liquid gas storage container of claim 1, wherein each of the plurality of support members have a linear thermal expansion coefficient of less than about 2×10⁻⁶ and a difference in angle between a first connection point of the first end and a second connection point of the second end of each of the plurality of support members, as measured from a central point within the inner shell, is determined using a formula of
$$θ o = ArcCos = [ - \frac{- 8 {r}_{2} - 4 ( {r}_{2} - {r}_{4} )}{8 {r}_{1}} ] ∓ {5}^{∘} ,$$
wherein θo is the difference in angle between the first connection point and the second connection point, r₂ is a radius of the inner shell at an ambient temperature, r₄ is a radius of the inner shell at a cryogenic temperature, and r₁ is a radius of the outer shell at the ambient temperature.

12. A liquid gas storage container comprising:
an inner shell, comprising:
an inner surface forming a cavity; and
an outer surface;
an outer shell disposed around the inner shell; and
a plurality of support members disposed between the inner shell and the outer shell, each of the plurality of supports comprising;
a first end coupled to the inner shell at an angle about tangent to the outer surface of the inner shell at a point where the first end is closest to the outer surface;
a second end coupled to the outer shell; and
a bracket offsetting the first end from the outer surface of the inner shell.

13. The liquid gas storage container of claim 12, wherein a cross section of each of the inner shell and the outer shell is circular, such that a first cross section of the inner shell is concentric with a second cross section of the outer shell.

14. The liquid gas storage container of claim 12, wherein the bracket includes a pin and the first end is coupled to the pin, such that the support member actuates about a central axis of the pin during heating or cooling of the inner shell.

15. The liquid gas storage container of claim 14, wherein two support members are coupled to the same bracket at the first end, such that both of the support members are coupled to the pin and both support members actuate about the central axis of the pin during heating or cooling of the inner shell.

16. The liquid gas storage container of claim 12, wherein a difference in angle between a first connection point of the first end and a second connection point of the second end of each of the plurality of support members, as measured from a central point within the inner shell, is determined using a formula of
$$θ o = ArcCos [ \text{} \frac{2 {r}_{2} ( {r}_{2} - {r}_{4} ) + {( {r}_{2} - {r}_{4} )}^{2} - {( {r}_{2} - {r}_{4} )}^{2} ϵ th ( 2 + ϵ th ) - {{r}_{1}}^{2} ϵ th ( 2 + ϵ th )}{2 {r}_{1} ( ( {r}_{2} - {r}_{4} ) - {r}_{2} ϵ th ( 2 + ϵ th ) )} ] ∓ {5}^{∘} ,$$
wherein θo is the difference in angle between the first connection point and the second connection point, r₂ is a radius of the inner shell at an ambient temperature, r₄ is a radius of the inner shell at a cryogenic temperature, r₁ is a radius of the outer shell at the ambient temperature, and eth is an average thermal strain of each of the plurality of support members across a length of each of the plurality of support members.

17. The liquid gas storage container of claim 1, wherein each of the plurality of support members have a linear thermal expansion coefficient of less than about 2×10⁻⁶ and a difference in angle between a first connection point of the first end and a second connection point of the second end of each of the plurality of support members, as measured from a central point within the inner shell, is determined using a formula of
$$θ o = ArcCos = [ - \frac{- 8 {r}_{2} - 4 ( {r}_{2} - {r}_{4} )}{8 {r}_{1}} ] ∓ {5}^{∘} ,$$
wherein θo is the difference in angle between the first connection point and the second connection point, r₂ is a radius of the inner shell at an ambient temperature, r₄ is a radius of the inner shell at a cryogenic temperature, and r₁ is a radius of the outer shell at the ambient temperature.

18. A liquid gas storage container comprising:
an inner shell, comprising:
a first inner surface forming a cavity; and
a first outer surface;
an outer shell disposed around the inner shell and comprising a second inner surface; and
a support structure disposed between the first outer surface and the second inner surface and comprising:
a first support ring contacting the first outer surface;
a second support ring contacting the second inner surface; and
a plurality of support members disposed between the inner shell and the outer shell, each of the plurality of supports comprising;
a first end coupled to a first bracket within the first support ring, the first end disposed at an angle about tangent to the outer surface of the inner shell at a point where the first end is closest to the outer surface; and
a second end coupled to a second bracket within the second support ring.

19. The liquid gas storage container of claim 18, wherein the first bracket offsets the first end of the support member from the first outer surface.

20. The liquid gas storage container of claim 19, wherein the first bracket includes a first pin and the second bracket include a second pin, such that the first end of the support member is coupled to the first pin while the second end of the support member is coupled to the second pin and the support member actuates around each of the first pin and the second pin during heating or cooling of the inner shell.
